(19) United States
(12) Patent Application Publication
(10) Pub. No.: US 2006/0014507 A1
(43) Pub. Date: Jan. 19, 2006

(54) Radio receiver

(76) Inventors: Diego Giancola, Cambridge (GB); Thomas Keller, Cambridgeshire (GB)

Correspondence Address: JOHN S. PRATT, ESQ;KILPATRICK STOCKTON, LLP, 1100 PEACHTREE STREET, ATLANTA, GA, 30309, US

(21) Appl. No.: 10/432,312

(22) PCT Filed: Nov. 19, 2001
(86) PCT No.: PCT/GB01/05103

§ 371 Date: Jul. 2, 2004

(30) Foreign Application Priority Data
Nov. 21, 2000 (GB) 0028375.4

(51) Int. Cl. H04B 1/06; H04B 7/00

(52) U.S. Cl. 455/232.1

(57) ABSTRACT

A radio receiver (30) comprises an ADC (13) including a clip counter. The power of digitised signals provided by the ADC (13) is estimated by a power estimator (31), and an ideal gain value is computed from the power so estimated by a gain computation device (32). Gain computation signals are fed to a gain control input of an amplifier (11) via an LPF (33). A saturation detector (34) is connected to a clip counter output of the ADC (13), and to a control input of the LPF (33). The saturation detector (34) is arranged when saturation of the ADC is detected to reduce the gain setting value by at least two steps, by which the gain of the amplifier is immediately reduced. A detector detects the Doppler frequency of signals received and accordingly determines the size of the drop in amplification which is effected when saturation of the ADC (13) is detected. The gain reduction may be 3 dB under very low Doppler shift conditions and 12 dB under very high Doppler shift conditions.

This invention relates to a radio receiver and in particular, although not exclusively, to a code division multiple access radio receiver.

A known form of code division multiple access (CDMA) radio receiver 10 is shown in FIG. 1. Referring to FIG. 1, the radio receiver 10 includes a controllable gain amplifier 11 interposed between a radio circuit 12 including a downconverter (not shown), and an analogue-to-digital converter (ADC) 13. The radio circuit 12 receives radio frequency signals from an antenna 14.

Digital signals are provided by the ADC 13 on an output 15, from which the signals are extracted for processing. A power estimator 16 is also connected to the output of the ADC 13. The power estimator 16 examines the digital signals, and provides an output signal indicative of the power of the received signal at regular intervals, typically 30,000 times a second or so. The power estimator 16 may be implemented in software or in hardware.

Since the power of the received signals depends to some extent on the information that is modulated onto it, the instantaneous output of the power estimator 16 is not truly indicative of the strength of the signal being received. It is the signal strength which is of interest although, since this is not directly measurable, it is estimated from power estimations. To avoid information-dependent changes in the power estimation having an effect on the signal strength estimation, it is usual to include a low-pass filter (LPF) 17 downstream of the power estimator 16. The LPF 17 may be a relatively simple device, in hardware or in software, which averages the signals provided by the power estimator 16 over time. The average signals are provided on an output 18, from where they are fed to the input of a gain controller 19, which sets the gain setting of the controllable gain amplifier 11.

The gain of the amplifier 11 is controllable to adopt any of a number of discrete regular steps of 0.5 dB from 10 dB to 80 dB. It is usual to detect the averaged signals at the output, to compare the signals to a threshold level at regular intervals, and to increment or to decrement the gain of the amplifier depending whether the averaged signal is lower than or greater than the threshold respectively. The aim is to keep the output of the amplifier 11 at a level at which the ADC 13 can work well.

In accordance with a first aspect of this invention there is provided a radio receiver comprising: a downconverter; a controllable gain amplifier connected to receive signals from the downconverter, the gain of the amplifier being controllable to adopt any of a plurality of discrete values in a series of steps; an analogue-to-digital converter, arranged to sample signals provided by the amplifier; and a monitor arranged to monitor signals provided by the analogue-to-digital converter and to reduce the gain of the amplifier by at least two of the steps if a predetermined level of saturation of the analogue-to-digital converter is detected.

A receiver constructed according to this aspect of the invention can offer improved performance, especially in fast fading channel environments. There are two influencing factors. Firstly, the invention does not need a low-pass filter in the path leading to amplifier gain reduction, which eliminates a cause of delay (filters necessarily delay signals). Secondly, the amplifier gain may be reduced by more than a single step for each control interval, which provides advantages since it is possible for the strength of a received signal to rise at a rate greater than can be compensated for by conventional one-step incremental/decremental radio receivers.

Preferably, the monitor is arranged to reduce the gain of the amplifier by an amount dependent on the fading characteristics of the channel over which a received signal is transmitted. This allows the construction of an adaptive radio receiver which reduces the amplifier gain by an amount which is appropriate for the channel.

In accordance with a second aspect of the invention, there is provided a radio receiver comprising, in sequence: a downconverter; a controllable gain amplifier an analogue-to-digital converter (ADC); a gain computation device, arranged to provide a gain setting signal on the basis of the sampled signal; and a filter device having a memory, the filter device being arranged to filter the gain setting signal and to provide the filtered signal to a gain setting input of the controllable gain amplifier, representation of the filtered gain setting signal being stored in the memory; a monitor arranged to monitor signals provided by the ADC and to detect a predetermined level of saturation of the ADC therefrom; and means to reduce the gain setting signal in response to the predetermined level of saturation being detected.

Embodiments of the present invention will now be described, by way of example only, with reference to the accompanying drawings, of which:

FIG. 1 shows schematically a prior art CDMA radio receiver; and

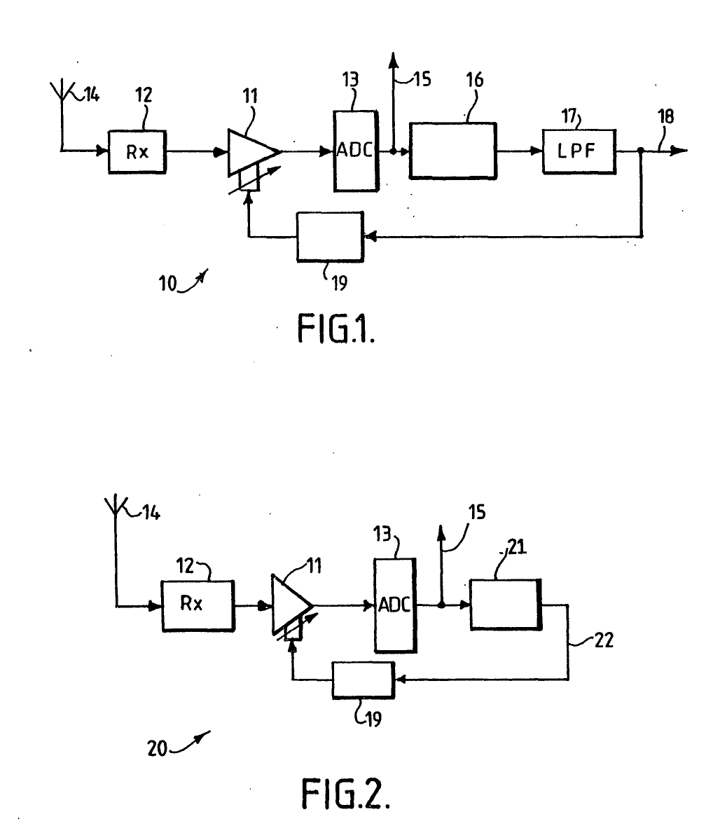

FIG. 2 shows schematically a CDMA radio receiver according to a first embodiment of this invention;

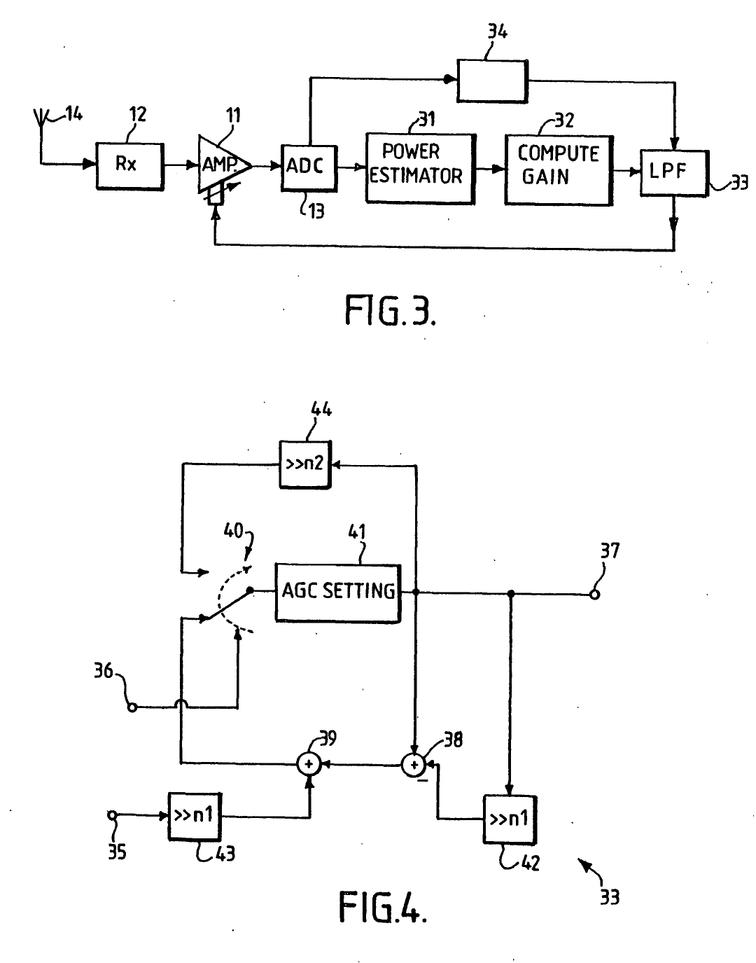

FIG. 3 shows schematically a CDMA radio receiver according to a second embodiment of this invention; and

FIG. 4 shows schematically the low pass filter (LPF) of FIG. 3 in detail.

Referring to the drawings, FIG. 2 shows a radio receiver 20. Reference numerals have been retained from FIG. 1 for like elements. Although not shown, the receiver 20 includes the power estimator 16 and the LPF 17 of FIG. 1 for conventional control of the gain of the amplifier 11, i.e. in a single-step incremental/decremental manner. The receiver 20 also includes a monitor 21, which is arranged to monitor the signals provided by the ADC 13.

During normal operation, i.e. where the channel has sufficiently low fading characteristics, operation is as described above with reference to FIG. 1. Where the channel fading characteristics are not so low, the ADC 13 may occasionally saturate, i.e. the signal level at its input becomes equal to, or greater than, the maximum level that it can faithfully sample. When the monitor 21 detects a predetermined level of saturation, from examination of the output of the ADC 13 for a number of digital signals corresponding to the maximum level, it provides a signal pulse on an output 22, which is connected to the gain controller 19. This signal pulse causes the gain of the amplifier 11 to be reduced by 6 dB, or twelve steps, instantly, although the reduction may be anywhere between 3 dB and 12 dB. The ADC 13 subsequently receives signals from the amplifier 11, which signals are at a suitable level for analogue-to-digital conversion within the operating range of the ADC 13. Following this gain reduction, gain control is effected by the power estimator 16, the gain controller 19 and the LPF 17 until saturation of the ADC 13 is again detected.

Reducing the gain of the amplifier 11 in this way presents significant disadvantages. In particular, one or two fifteenths of a frame of data may be corrupted to the extent that it is not recoverable. Also, where the radio receiver 20 includes a rake receiver (a receiver in which plural rays are detected and subsequently combined), signal tracking for fingers of the rake receiver is not possible for a short but significant period of time. However, the inventors feel that the advantages outweigh these disadvantages, the main advantage being that the negative effects of ADC saturation are substantially avoided. As will be appreciated, these negative effects include high noise levels in the signals provided at the output 15, and interference with the power control algorithm. The latter may on occasion cause the transmitter power to be increased, further increasing the problem, so its avoidance is an advantage.

In a preferred embodiment (not shown) a detector detects the Doppler frequency of signals received, in a conventional manner, and accordingly determines the size of the drop in amplification which is effected when saturation of the ADC 13 is detected. The larger the Doppler shift, the faster changing the channel fading characteristics are assumed to be and hence the larger the drop in gain. It is expected that the gain may be dropped by 3 dB for very low Doppler shift conditions and by 12 dB for very high Doppler shift conditions in a typical radiotelephone receiver.

To detect saturation of the ADC 13, the monitor 21 typically examines the output of the ADC and counts the number of samples for which the ADC clips the maximum signal level which the ADC can provide. The count is made for clips in both the positive and negative directions. The number of clips are counted over an update period of 10,000 chips, which is the interval between updates of the gain of the amplifier 11, and the number of clips detected is compared to a threshold. In this embodiment, the threshold is 1,000 chips, or 10% of the number of chips in an update period. However, the threshold selected for a particular implementation depends on particularly the length of the update period and the resolution of the ADC 13.

Alternatively, the ADC 13 may be designed so as to include its own clip detector, so that it is only clip counting and thresholding which is performed by the monitor 21. The monitor 21 may be called a saturation detector.

FIG. 3 shows a preferred CDMA radio receiver 30 according to the invention. Referring to FIG. 3, the radio receiver 30 comprises an ADC 13 including a clip counter. The power of digitised signals provided by the ADC 13 is estimated by a power estimator 31, and an ideal gain value is computed from the power so estimated by a gain computation device 32 in a known manner. Gain computation signals are fed to a gain control input of the amplifier 11 via an LPF 33, which is shown in FIG. 4, described below. A saturation detector 34 is connected to a clip counter output of the ADC 13, and to a control input of the LPF 33. The saturation detector 34 provides a logic “one” signal on its output when saturation of the AGC is determined in the manner described above with reference to FIG. 3, and a logic “zero” signal otherwise.

The LPF 33 is arranged, on receipt of a logic “one” signal from the saturation detector 34, to reduce the gain setting value by at least two steps, by which the gain of the amplifier is immediately reduced. The LPF 33 is shown in more detail in FIG. 4.

Referring to FIG. 4, the LPF 33 comprises a first input 35 which is connected to the output of the gain computation device 32, a second input 36 which is connected to the saturation detector 34, an output 37, first and second adders 38, 39, a controllable switch 40, a gain setting memory device 41 and first to third bit shifting devices 42 to 44.

In normal operation, i.e. when the saturation detector 34 provides a logic “zero” output, the switch 40 rests as shown in the figure. In this condition, a gain setting output of the memory device 41 is connected to its own input via the first and second adders 38, 39. The gain setting number is first reduced by subtraction, in the first adder 38, of a fraction of the gain setting number, which fraction is provided by the first bit shifter 42. The first bit shifter 42, as with the second bit shifter 43, shifts the binary gain setting number to the right by n1 bits, effectively dividing the gain setting number by 2ⁿ¹. The resulting number is then increased, in the second adder 39, by an amount equal to the gain setting signal provided by the gain computation device 32 divided by 2ⁿ¹. The resulting number is then passed, via the switch 40, to the input of the AGC setting memory device 41 to set the gain setting number for the next gain setting period. In steady state conditions, therefore, the output 37 shows a gain setting number which is equal to that of the input of the gain computation device 32. Where this input signal varies, the LPF 33 serves as a low pass filter, averaging its input signals to provide a smoothed output. When the input signal changes rapidly, the LPF 33 does not react instantly, since its architecture introduces a delay, as is conventional with low pass filters. The extent of the delay and the other main characteristics of the LPF 33 are determined by the value of n1 and the length of the gain setting number.

When a logic “one” signal is received at the second input 36, indicative of an ADC saturation condition, the controllable switch 40 is switched over. In this position, the input of the AGC setting memory device 41 is connected to an output of the third bit shifter 44, which has its input connected to the output of the AGC setting memory device. Accordingly, in this condition, the AGC setting memory device 41 receives at its input a gain setting number which is equal to its output gain setting number divided by 2ⁿ². This effects a dramatic decrease in the gain setting number over a single gain setting period, which results in an immediate decrease in the gain setting of the amplifier 11. The value of n2 is chosen, having regard to the length of the gain setting number, to result in the amplifier gain being reduced by an amount in the range 3 dB to 12 dB.

Preferably, the value of n2 is dynamically controllable, and is determined on the basis of a detected Doppler frequency of signals received; as is discussed above in relation to the FIG. 2 embodiment.

1. A radio receiver comprising:
a downconverter;
a controllable gain amplifier connected to receive signals from the downconverter, the gain of the amplifier being controllable to adopt any of a plurality of discrete values in a series of steps;
an analogue-to-digital converter, arranged to sample signals provided by the amplifier; and
a monitor arranged to monitor signals provided by the analogue-to-digital converter and to reduce the gain of the amplifier by at least two steps in response to a predetermined level of saturation of the analogue-to-digital converter being detected.

2. A receiver as claimed in claim 1, in which the monitor is arranged to reduce the gain of the amplifier by an amount in the range 3 dB to 12 dB when the predetermined level of saturation is detected.

3. A receiver as claimed in claim 1, in which the monitor is arranged to reduce the gain of the amplifier by an amount dependent on the fading characteristics of the channel over which a received signal is transmitted.

4. A receiver as claimed in claim 3, in which the fading characteristics are estimated by a detector arranged to detect the Doppler frequency of the received signal.

5. A radio receiver comprising, in sequence:
a downconverter;
a controllable gain amplifier;
an analogue-to-digital converter (ADC);
a gain computation device arranged to provide a gain setting signal on the basis of the output signal of the ADC; and
a filter having a gain setting memory device, the filter being arranged to filter the gain setting signal and to provide the filtered signal to a gain setting input of the controllable gain amplifier; and
a monitor arranged to monitor signals provided by the ADC and to detect a predetermined level of saturation of the ADC thereform; wherein
the output of the gain setting memory device is connected to its input and the gain setting memory device is in a first operating condition when the monitor detects said predetermined level of saturation, whereby the gain setting memory device reduces the gain of the amplifier by a predetermined amount.

6. A radio receiver as claimed in claim 5, wherein the gain of the amplifier is controllable to adopt any of a plurality of discrete values in a series of steps, and the gain setting memory device replaces the gain of the amplifier by at least two steps when the gain setting memory device is in the first operation condition.

7. A radio receiver as claimed in claim 5, wherein the gain setting memory device is in a second operating condition when the monitor does not detect said predetermined level of saturation.

8. A radio receiver according to claim 5, in which the reduction of the gain setting signal effects an amplifier gain reduction of between 3 dB and 12 dB.

9. A radio receiver according to claim 5, in which the extent of reduction of the gain setting signal is dependent on the fading characteristics of the channel over which a signal is received.

10. A radio receiver according to claim 9, in which the fading characteristics are estimated by a detector arranged to detect the Doppler frequency of the received signal.

11. A receiver as claimed in claim 2, in which the monitor is arranged to reduce the gain of the amplifier by an amount dependent on the fading characteristics of the channel over which a received signal is transmitted.

12. A radio receiver as claimed in claim 6, wherein the gain setting memory device is in a second operating condition when the monitor does not detect said predetermined level of saturation.

13. A radio receiver according to claim 6, in which the reduction of the gain setting signal effects an amplifier gain reduction of between 3 dB and 12 dB.

14. A radio receiver according to claim 7, in which the reduction of the gain setting signal effects an amplifier gain reduction of between 3 dB and 12 dB.

15. A radio receiver according to claim 6, in which the extent of reduction of the gain setting signal is dependent on the fading characteristics of the channel over which a signal is received.

16. A radio receiver according to claim 7, in which the extent of reduction of the gain setting signal is dependent on the fading characteristics of the channel over which a signal is received. Page 5

17. A radio receiver according to claim 8, in which the extent of reduction of the gain setting signal is dependent on the fading characteristics of the channel over which a signal is received.
